(19) United States
(12) Patent Application Publication
(10) Pub. No.: US 2013/0087614 A1
(43) Pub. Date: Apr. 11, 2013

(54) AUDIO JACK COUPLED SECURE MAGNETIC CARD READER

(71) Applicants: Emmanuel C. Limtao, Bellflower, CA (US); Chia-Chi Hsu, Seal Beach, CA (US)

(72) Inventors: Emmanuel C. Limtao, Bellflower, CA (US); Chia-Chi Hsu, Seal Beach, CA (US)

(73) Assignee: Mag Tek, Inc., Seal Beach, CA (US)

(21) Appl. No.: 13/270,177

(22) Filed: Oct. 10, 2011

(51) Int. Cl. G06K 7/08

(52) U.S. Cl. 235/449

(57) ABSTRACT

Audio jack coupled secure magnetic card readers in accordance with embodiments of the invention are described. One embodiment includes reading data from at least one track of data encoded on a magnetic stripe using a magnetic read head, encrypting the data using an encryption circuit, encoding the encrypted data into a transmission format using an encoder, passing the encoded data through an anti-aliasing filter to generate a data signal, and transmitting the data signal. on the microphone channel of an audio jack.

### FIELD OF THE INVENTION

The invention relates generally to magnetic stripe readers and more specifically to magnetic stripe readers that communicate data via an audio jack.

### BACKGROUND OF THE INVENTION

Since their inception, almost all cellular phones (“cell phones”) have had some type of audio input and output capability. An audio-type jack would normally be used to connect a “hands-free” headset, which includes at least one earphone sized speaker near the user's ear and a microphone either suspended near the user's mouth or attached along the cable of the headset.

While earlier phones had a 2.5 mm diameter audio jack, most current phones have a 3.5 mm jack—the dominant size used on headphones in portable consumer electronics.

TRS (tip, ring, sleeve) is a common family of connector typically used for analog signals including audio. It is cylindrical in shape, most commonly with three contacts but sometimes with two (a TS connector) or four (a TRRS connector). The TRS connector is also referred to as an audio audio jack, phone jack, stereo plug, and headphone jack. Jack plug and jack socket can be used to refer to male and female TRS connectors, respectively.

The TRS connector can provide multiple channels. A three- or four-conductor version of the 2.5 mm or 3.5 mm plug is used on cell phone hands-free headsets to provide mono (three conductor) or stereo (four conductor) sound and a microphone input.

More recent model cell phones harness greater computing power, enabling multimedia applications on cell phones such as playing MP3 audio files and streaming video. These capabilities contributed to the adoption of 3.5 mm plugs so that consumers could use their headphones to listen to audio through their phones.

“Smart phones” such as the iPhone and Google Android powered devices have a large memory capacity and processing power making them ripe for the development of peripheral devices. The Square Card Reader is a magnetic card reader that takes advantage of a smart phone's 3.5 mm audio jack as a communications interface. The Square Card Reader is a passive analog device that applies the voltage induced by a card swipe on the magnetic head to the microphone channel of the TRS connector. An application on the phone interprets the signal from the microphone channel to reconstruct the card data that was read. The device does not convert data into digital form or encrypt the data before transmitting it to the phone.

### SUMMARY OF THE INVENTION

Audio jack coupled secure magnetic card readers in accordance with embodiments of the invention include reading magnetic card data and transmitting the data in encrypted form over an audio jack. One embodiment includes reading data from at least one track of data encoded on a magnetic stripe using a magnetic read head, encrypting the data using an encryption circuit, encoding the encrypted data into a transmission format using an encoder, passing the encoded data through an anti-aliasing filter to generate a data signal, and transmitting the data signal on the microphone channel of an audio jack.

A further embodiment also includes detecting a unique magnetic characteristic that is inherent to the magnetic materials used to form the magnetic stripe of the magnetic stripe bearing document using the magnetic read head, encrypting a unique identifier derived from the detected unique magnetic characteristic, and combining the encrypted data read from the at least one track of data with the encrypted unique identifier.

In another embodiment encrypting the data includes encrypting the data using Triple DES Encryption Algorithm (TDEA) and Derived Unique Key Per Transaction (DUKPT).

In a still further embodiment encoding the encrypted data into a transmission format includes encoding the encrypted data using a Manchester code.

In still another embodiment encoding the encrypted data using Manchester code is performed using a 2 KHz clock signal.

A yet further embodiment also includes arranging the Manchester encoded data into character frames.

In a further embodiment, arranging the Manchester encoded data into character frames includes arranging the Manchester encoded data into 10 bit character frames.

In still another embodiment, transmitting the data signal on the microphone channel of an audio jack includes applying a voltage to the microphone channel where the voltage is representative of the data signal.

In a yet further embodiment, the voltage is 0 V for a logic low and 3 V for a logic high.

Yet another embodiment includes a magnetic read head configured to read and encrypt data from a magnetic stripe, a microcontroller connected to the magnetic read head and configured to convert encrypted data received from the magnetic read head into a transmission format, and an anti-aliasing filler connected between the microcontroller and a multi-channel audio jack, where the anti-aliasing filler is configured to output a transmission signal based upon data provided as an input in the transmission format.

In a further embodiment again, the magnetic read head is also configured to detect a magnetic fingerprint from a magnetic stripe.

A further embodiment again also includes a sensing unit to detect a unique magnetic characteristic that is inherent to the magnetic materials used to form the magnetic stripe of a magnetic stripe bearing document.

In a still further embodiment, the magnetic read head encrypts the data with Triple DES Encryption Algorithm (TDEA) and Derived Unique Key Per Transaction (DUKPT).

In yet another embodiment, the microcontroller is configured to generate Manchester encoded data.

In still yet another embodiment, the microcontroller is configured to generate a 2 KHz signal as a clock signal.

In a further embodiment, the multi-channel audio jack is a 3.5 mm TRRS connector with a microphone channel.

A still further embodiment also includes a rechargeable battery configured to provide power to circuitry within the magnetic card reader.

A yet further embodiment also includes a micro USB port connected to a charging circuit that is connected to the rechargeable battery.

A further embodiment includes receiving a signal on the microphone channel of a cell phone audio jack, sampling the signal with an analog to digital converter, decoding the data in the signal from its transmission format to obtain encrypted data, and transmitting the encrypted data to a transaction processor.

In still yet another embodiment, sampling the signal with an analog to digital converter includes sampling at 44.1 KHz.

In yet a further embodiment, decoding the data in the signal from its transmission format includes decoding a Manchester encoded data signal.

Still another embodiment includes an audio jack input configured to receive a transmitted signal, an analog to digital converter configured to sample the received signal, a data decoder configured to decode the sampled signal to obtain the encrypted data, and a processor configured by an application to send the encrypted data to a transaction processor.

In a further embodiment, the analog to digital converter is configured to sample at 44.1 KHz.

In a yet further embodiment, the data decoder is configured to decode Manchester encoded data.

In a still further embodiment, the audio jack input is configured to output electrical power on one or more conductors.

### BRIEF DESCRIPTION OF THE DRAWINGS

FIG. 1 is a side view of a magnetic stripe card reader in accordance with an embodiment of the invention.

FIG. 2 is a side view of a magnetic stripe card reader in accordance with an embodiment of the invention reading a magnetic stripe card.

FIG. 3 conceptually illustrates the location of a magnetic read head within the card path of a magnetic stripe card reader in accordance with an embodiment of the invention.

FIG. 4 conceptually illustrates a magnetic stripe card positioned so that the magnetic stripe is in contact with the magnetic reader head of a magnetic stripe card reader in accordance with an embodiment of the invention.

FIG. 5 is a flow chart illustrating a process for securely transmitting information read from a magnetic stripe of a magnetic stripe card to another device via an audio jack in accordance with an embodiment of the invention.

FIG. 6 is a circuit diagram illustrating an anti-aliasing filler in accordance with embodiments of the invention.

FIG. 7 conceptually illustrates the circuits of a secure magnetic stripe card reader in accordance with embodiments of the invention.

FIG. 8 is a flow chart illustrating a process for receiving encrypted data from a secure magnetic stripe card reader via an audio jack in accordance with an embodiment of the invention.

FIG. 9 conceptually illustrates the circuitry utilized to decode information received from a secure magnetic stripe card reader in accordance with embodiment of the invention.

### DETAILED DISCLOSURE OF THE INVENTION

Turning now to the drawings, audio jack coupled secure magnetic card readers in accordance with embodiments of the invention are illustrated. In many embodiments, the magnetic card reader has a slot with a magnetic read head situated along the slot. In several embodiments, the magnetic read head and/or the magnetic card reader includes circuitry configured to encrypt card data before digitally transmitting the encrypted card data to a phone or another device via an audio jack connector. In a number of embodiments, the magnetic card reader includes a 2.5 mm or 3.5 mm audio jack and the digital data is modulated for transmission over one or more conductors of the audio jack. In several embodiments, an application running on a mobile phone receives and demodulates the data from the microphone input using an analog to digital converter.

### Secure Magnetic Card Readers

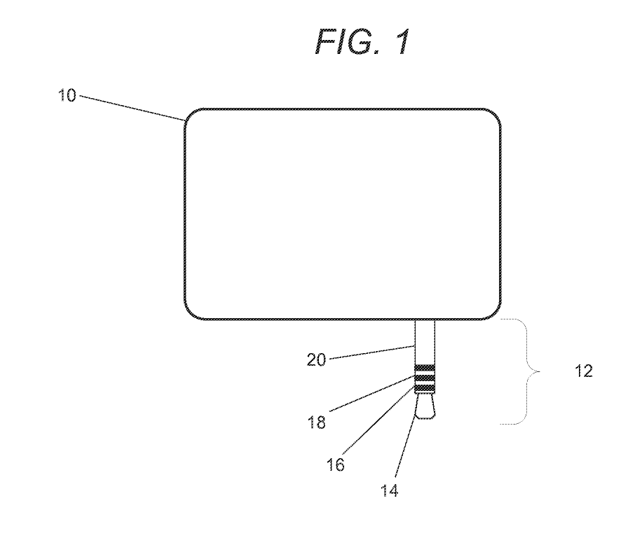

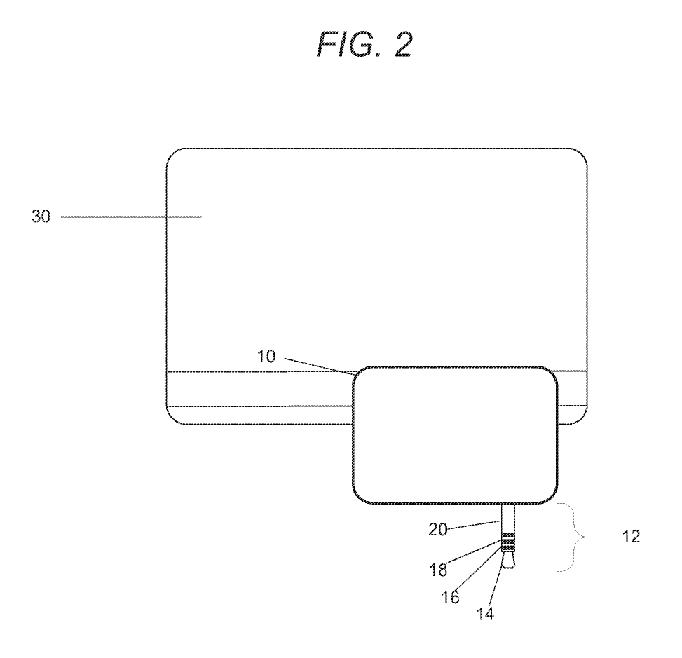

Audio jack coupled secure magnetic card readers in accordance with embodiments of the invention can take a variety of forms. An audio jack coupled secure magnetic card reader in accordance with an embodiment of the invention is shown in FIG. 1. The housing of the card reader 10 is roughly rectangular in shape, although it can be appreciated that the housing may be of any shape that can contain the reader components. A 3.5 mm, four-conductor TRRS connector 12 is located on the bottom of the housing. The TRRS connector 12 includes four conductors/contacts: tip 14, ring 16, ring 18, and sleeve 20. The conductors may be assigned different signals, but typically on a headset the tip 14 is left channel audio, first ring 16 is right audio channel, second ring 18 is a common ground, and sleeve 20 is microphone. The secure magnetic card reader of FIG. 1 is illustrated with a magnetic stripe card 30 inserted in FIG. 2.

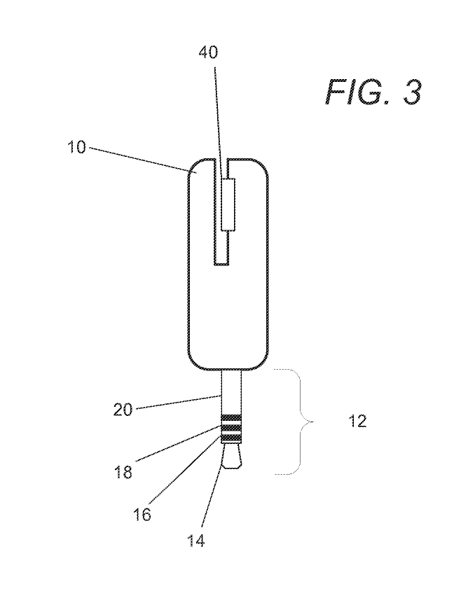

A side view of the card reader shown in FIG. 1 is illustrated in FIG. 3. In the side view, a card path is visible as a slot on the top of the reader. The magnetic read head 40 is located along one wall of the card path. While a card path formed as a slot facilitates reading of magnetic stripe cards, it is understood that the card path need not be a bounded path within the device. The card path can be bounded by walls of different sizes or can even be on the outer surface of the device. The magnetic read head 40 can be located on any portion of the device that allows a magnetic stripe card to pass over it for a valid reading.

In several embodiments, the magnetic read head is also configured to read information related to an intrinsic magnetic characteristic of the magnetic stripe card, which can be thought of as a magnetic fingerprint that can be utilized to uniquely identify the card. In other embodiments, a separate sensor is configured to detect an intrinsic magnetic characteristic of the magnetic stripe card. The intrinsic magnetic characteristic can be derived from a unique remnant noise characteristic of the card. A unique magnetic fingerprint can be useful in authenticating magnetic stripe cards and preventing the use of unauthorized copies of magnetic stripe cards. Systems and methods exist for sensing the noise characteristic and generating a magnetic fingerprint, such as those disclosed in U.S. patent application Ser. No. 10/997,150 entitled “Magnetic Stripe Authentication and Verification System,” U.S. Pat. No. 7,478,751 entitled “Method and Apparatus for Authenticating a Magnetic Fingerprint Signal Using a Filler Capable of Isolating a Remnant Noise Related Signal Component,” and U.S. Pat. No. 7,703,676 entitled “Encrypting the Output of a Card Reader in a Card Authentication System,” which are hereby incorporated by reference in their entirety.

Capturing a magnetic fingerprint with consistency often relies upon the magnetic read head being accurately aligned to a reference surface. When a magnetic stripe card contacts the reference surface on the card's reference edge as it is being read, the magnetic stripe will be aligned relative to the magnetic read head so that the read head is able to read the portion of the magnetic stripe containing the intrinsic magnetic characteristic that is utilized to derive the magnetic fingerprint of the card. In many embodiments, both the reference surface and the magnetic read head are located in fixed positions relative to each other. In other embodiments, the magnetic read head is fixed in relation to the reference surface, but the combination is mounted to pivot or float within the reader so that the reference surface aligns with the reference edge of the card and thus aligns the magnetic read head relative to the magnetic stripe.

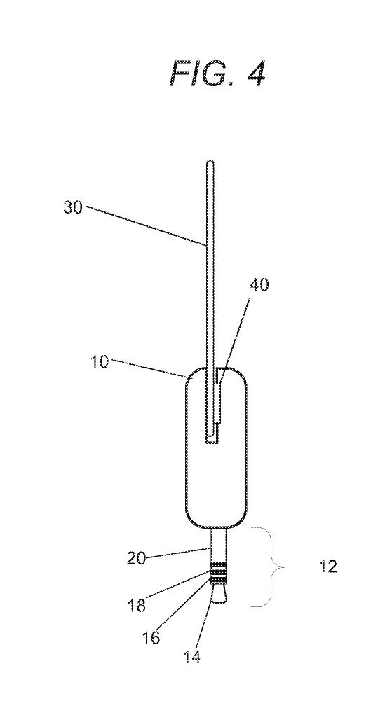

The secure magnetic card reader of FIG. 3 is illustrated with a magnetic stripe card 30 inserted into the slot in FIG. 4. Although a contacting magnetic read head is illustrated in FIGS. 3 and 4, as can be readily appreciated any of a variety of magnetic read head technologies including contactless magnetic read heads can be utilized to read data and/or capture information concerning the unique magnetic characteristic(s) that is inherent to the magnetic materials used to form the magnetic stripe. Processes for reading magnetic stripes and encrypting information for transmission in accordance with embodiments of the invention are discussed further below.

### Reading Magnetic Stripe Cards Using A Secure Magnetic Stripe Reader

Magnetic stripe card readers in accordance with embodiments of the invention read data encoded on one or more tracks of a magnetic stripe of a magnetic stripe card, encrypt the data, encode the data for transmission via an audio jack and transmit the data to another device via the audio jack. In several embodiments, the secure magnetic stripe card readers also capture magnetic fingerprint data from a magnetic stripe, encrypt the captured magnetic fingerprint data and transmit the encrypted magnetic fingerprint data with the encrypted data read from the magnetic stripe.

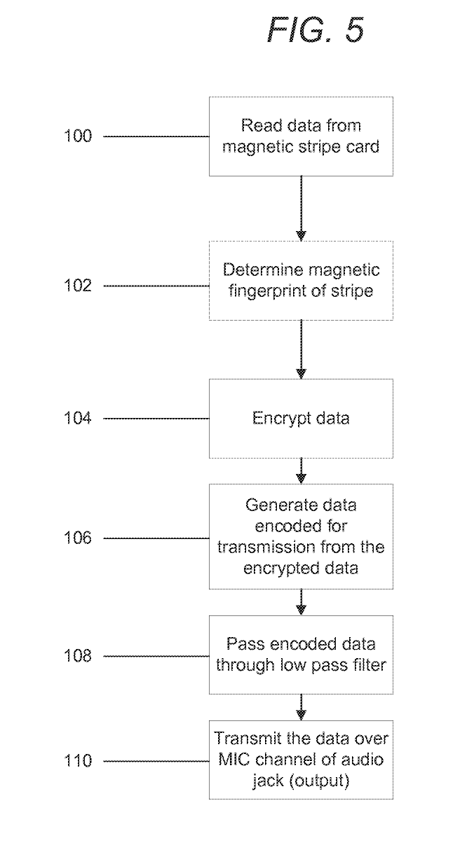

A process for reading data from a magnetic stripe card and transmitting the data to a device such as (but not limited to) a cell phone via an audio jack using a secure card reader according to an embodiment of the invention is shown in FIG. 5. As a magnetic stripe card is presented to the card reader, typically by “swiping” it, a magnetic read head reads data from one or more tracks of data encoded on the magnetic stripe (100). In several embodiments, the card reader includes a sensing unit in the magnetic read head or as a separate component that senses a unique magnetic characteristic(s) that is inherent to the magnetic materials used to form the magnetic stripe (102) (i.e., characteristics that are unrelated to the data encoded on the magnetic stripe). Techniques exist to detect magnetic characteristic data and waveform (or range) data and to authenticate a particular card using the data, such as those disclosed in U.S. patent application Ser. No. 10/997,150 entitled “Magnetic Stripe Authentication and Verification System,” U.S. Pat. No. 7,478,751 entitled “Method and Apparatus for Authenticating a Magnetic Fingerprint Signal Using a Filler Capable of Isolating a Remnant Noise Related Signal Component,” and U.S. Pat. No. 7,703,676 entitled “Encrypting the Output of a Card Reader in a Card Authentication System,” which are hereby incorporated by reference in their entirety. The unique identifying information derived through these techniques can be thought of as a magnetic fingerprint.

The recorded data and, optionally, the magnetic fingerprint data is encrypted (104) using an encryption technique such as (but not limited to) Triple DES Encryption Algorithm (TDEA) and Derived Unique Key Per Transaction (DUKPT). Other suitable encryption algorithms and key management methods are well known in the art. Encryption can occur on the magnetic read head or using a separate component within the secure magnetic stripe reader. In a number of embodiments, the components that access the data from the magnetic stripe reader in the clear are packed within tamper resistant and/or tamper proof packaging systems.

The encrypted data is converted into a format suitable for transmission (106). One format known in the art and commonly used in telecommunications is Manchester code, where the encoding of each bit has at least one transition and occupies the same time period. Thus, an equal number of zeros and ones are generated and overall data rate is reduced in half. The DC component of the encoded signal is not dependent on the data and therefore carries no information. Furthermore, if a clock signal was used to generate the coded signal, a receiver can recover the clock signal from the encoded data.

In many embodiments, the data is Manchester encoded by performing an exclusive OR (XOR) operation on sequential blocks of the data with a generated 2 KHz square wave signal. A 0 is thus expressed by a low-to-high transition and a 1 by a high-to-low transition at the middle of each bit period. Any transitions at period boundaries merely place the signal in the correct state to allow the mid-bit transition and do not carry information.

Character framing can be used to facilitate detection and synchronization of the Manchester encoded signal at the receiver. A number of embodiments utilize frames of different set lengths. In many embodiments, the Manchester encoded data is arranged into 10 bit character frames, where a frame comprises a logic low start bit, 10 bits of data representing the data, an optional parity bit, and two logic high stop bits. Because the start bit is logic low and the stop bit is logic high, there is always a clear demarcation between the previous character and the next character. The statistical likelihood is extremely low that a low-high-high pattern is found repeatedly spaced 10 bits apart in the encoded data. Various embodiments can have a varying number and/or combination of start, character, and/or end bits, so long as the pattern of start and stop bits can be distinguished over a number of frames.

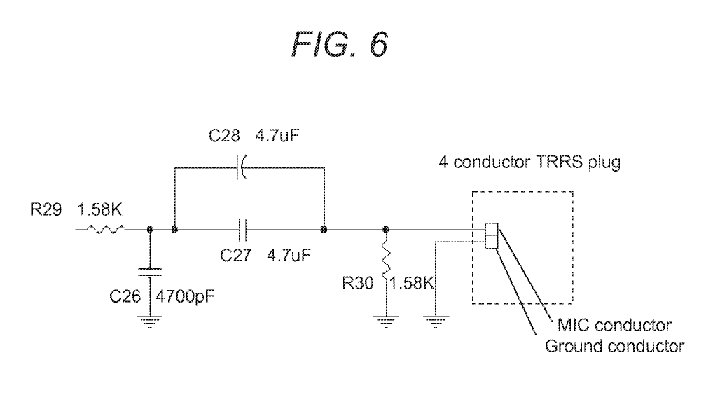

The Manchester encoded data is passed through an anti-aliasing low-pass filter (108) to reduce high frequency components of the square wave signal. Aliasing and inter symbol interference (151) can impact the ability of the receiver to reconstruct and interpret data from the transmitted signal. The frequency content of a square wave, as defined by the Fourier transform, has no upper bound. Some amount of aliasing always occurs when such a signal is sampled. The Nyquist-Shannon sampling theorem cannot be satisfied to perfectly reconstruct a square wave. A low-pass or band pass filler can be used to limit the frequency components of the signal so that it can be more completely recovered by a receiver. A circuit diagram of an anti-aliasing filler connected to a TRRS audio jack in accordance with embodiments of the invention is shown in FIG. 6.

The filtered data signal is then transmitted (110) over the microphone (MIC) channel of an audio jack by varying the voltage applied to the channel over a fixed range. Various embodiments of the invention use a three conductor/channel TRS (mono/MIC/ground) or four-channel TRRS (left/right/MIC/ground) connector in 2.5 mm diameter or 3.5 mm diameter as an audio jack. However, secure magnetic stripe card readers in accordance with embodiments of the invention are not limited to the type, size, or configuration of the connector. The voltage range can be determined from the input capabilities of the audio jack of the cell phone or device used to receive the signal. A logic low is represented by one voltage within the range detectable by the audio jack input and a logic high is represented by a different voltage within the range. In some embodiments, the signal is transmitted at a fixed reference voltage of 3 V. Logic low is signaled by 0 V, and logic high is signaled by 3 V. In other embodiments, any of a variety of voltages can be utilized.

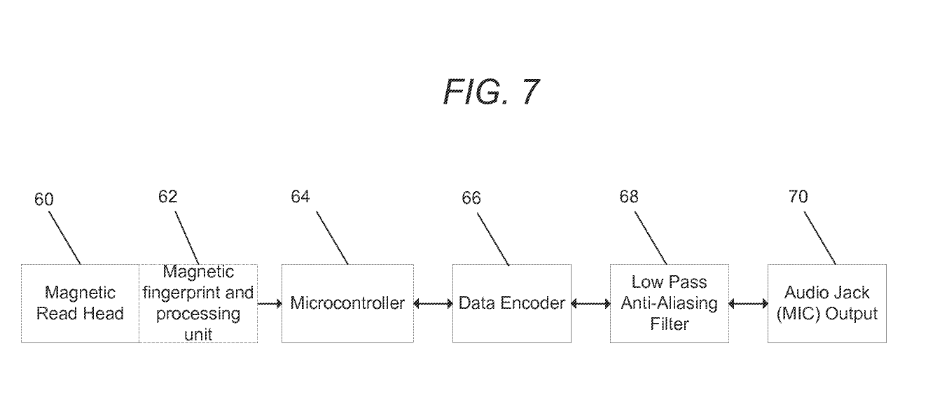

A block diagram of a secure magnetic stripe card reader in accordance with an embodiment of the invention is shown in FIG. 7. A magnetic read head 60 captures data recorded on one or more tracks of the magnetic stripe of a card that is swiped through the reader. The read head 60 encrypts the data using an encryption process such as (but not limited to) Triple DES Encryption Algorithm (TDEA) and Derived Unique Key Per Transaction (DUKPT). Other suitable encryption algorithms and key management methods such as Advanced Encryption Stardard (AES) can also be utilized in accordance with embodiments of the invention Encryption can occur on the magnetic read head or on separate component.

Many embodiments include a magnetic fingerprint sensing and processing unit 62 integrated into the magnetic read head 60 or as a separate component. Systems and methods exist for sensing a unique characteristic inherent to the magnetic medium on which the data is encoded and generating a magnetic fingerprint, such as those disclosed in U.S. patent application Ser. No. 10/997,150 entitled “Magnetic Stripe Authentication and Verification System,” U.S. Pat. No. 7,478,751 entitled “Method and Apparatus for Authenticating a Magnetic Fingerprint Signal Using a Filter Capable of Isolating a Remnant Noise Related Signal Component,” and U.S. Pat. No. 7,703,676 entitled “Encrypting the Output of a Card Reader in a Card Authentication System,” which are hereby incorporated by reference in their entirety.

A microcontroller 64 generates a 2 KHz square wave signal and a data encoder 66 exclusive OR's (XOR's) the encrypted card data and/or the magnetic fingerprint information with the 2 KHz signal to generate Manchester encoded data as described above. The encoder can arrange the Manchester encoded data into character frames to facilitate detection and synchronization of the Manchester encoded signal at the receiver, also described above. In many embodiments, the functions of the microcontroller and data encoder are combined in a single microcontroller, such as a 8051 core C8051F346-GMR microcontroller, which can generate the 2 KHz clock signal and XOR the encrypted card data with the clock signal to generate the Manchester encoded data, as well as arrange the data into character frames.

A band pass anti-aliasing filter 68 removes high frequency components from the square wave signal generated by the encoder 66. As discussed above, abasing can impact the ability of the receiver to reconstruct and interpret data from the transmitted signal. A low-pass filter can be used to limit aliasing by limiting the frequency components of the signal so that it can be more completely recovered by a receiver. A circuit diagram for a band pass filter connected to a TRRS audio jack in accordance with embodiments of the invention is shown in FIG. 6. Although the illustrated filter is a passive band pass filter, any of a variety of filter circuits including active and passive filler circuits can be utilized depending upon the requirements of a specific application in accordance with embodiments of the invention.

A multi-channel audio jack 70 receives the filtered signal and applies the signal to its MIC conductor/channel by varying the voltage applied to the channel over a fixed range. Various embodiments of the invention use a three conductor/channel TRS (mono/MIC/ground) or four-channel TRRS (left/right/MIC/ground) connector in 2.5 mm diameter or 3.5 mm diameter as an audio jack. However, the invention is not limited to the type, size, or configuration of the connector. The voltage range can be determined from the input capabilities of the audio jack of the cell phone used to receive the signal. A logic low is represented by one voltage within the range detectable by the cell phone input and a logic high is represented by a different voltage within the range. In some embodiments, the signal is transmitted at a fixed reference voltage of 3 V. Logic low is signaled by 0 V, and logic high is signaled by 3 V.

Secure magnetic card readers in accordance with various embodiments of the invention utilize hardware or software buffers to communicate data between magnetic read head 60, microcontroller 64, and data encoder 66. Other embodiments of the invention utilize a data streaming process to pass the data.

The circuitry in secure magnetic card readers in accordance with various embodiments of the invention can be powered by on-board batteries. The on-board batteries may be rechargeable or non-rechargeable, and removable or non-removable. Embodiments of the invention utilizing rechargeable batteries also include a charging port that can be a micro USB, mini USB, USB, coaxial/cylindrical, Molex, or other proprietary or non-proprietary power connector. Many other embodiments of the invention are powered by voltage/current applied to channels/conductors of the audio jack input to which the audio jack of the secure magnetic card reader is connected, such as the conductors for left and right audio channels.

### Receiving Data From A Secure Magnetic Stripe Reader

Cell (mobile) phones or other capable electronic devices in communication with a secure magnetic stripe reader in accordance with embodiments of the invention receive the data transmitted from the audio jack of the secure magnetic stripe reader, sample the signal to recover digitally represented data, decode the Manchester encoded data, and transmit the data in its still-encrypted form to a transaction processor.

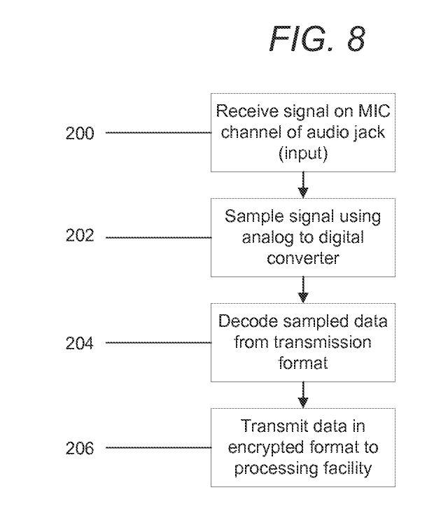

A process for receiving data transmitted from a secure card reader to a cell phone according to an embodiment of the invention is shown in FIG. 8. A signal is received on the microphone (MIC) channel of the cell phone's audio jack (200). The signal is sampled and processed by an Analog to Digital Converter (ADC) (202). Several embodiments of the invention are configured for a 44.1 KHz sampling rate, providing an approximately 20 times oversample of the 2 KHz Manchester encoded data. Oversampling can also be performed at other rates such as 22,050 Hz, 48 KHz, or 96 KHz. In other embodiments, any of a variety of sampling rates can be utilized in accordance with the requirements of a specific application. Oversampling at a frequency significantly higher than twice the bandwidth or highest frequency in the signal being sampled (i.e., sufficient to satisfy the Nyquist-Shannon sampling theorem) helps avoid aliasing, improves resolution, and reduces noise. Oversampling also relaxes the requirements of an anti-aliasing filter used to generate the signal sampled. By increasing the bandwidth of the sampled signal, the anti-aliasing filter can be less complex and thus less expensive. Furthermore, oversampling can reduce noise. If multiple samples are taken of the same quantity with uncorrelated noise added to each sample, then averaging N samples reduces the noise power by a factor of 1/N.

The samples of the Manchester encoded data are reconstructed into an approximation of the original signal and the data is decoded from the Manchester format (204). The decoding algorithm can be implemented in hardware or in software as an application on the cell phone. Because Manchester coded data inherently incorporates a clock signal, the receiver can synchronize to the transmitter's clock after receiving two or more data bit periods. The decoding algorithm detects low-to-high and high-to-low transitions in the signal and translates them to logic low and logic high bits in a reverse process to the encoding process described above.

In several embodiments, data is arranged into character frames, and the decoding algorithm is designed to detect start and stop bits, and check against a parity bit if one is used. One embodiment utilizes 10 bit character frames, where a frame comprises a logic low start bit, 10 bits of data representing the payload data, an optional parity bit, and two logic high stop bits. Because the start bit is logic low and the stop bit is logic high, there is always a clear demarcation between the previous character and the next character. The decoding algorithm detects the transition between frames as two logic high stop bits and a logic low start bit, and checks the frame parity against the parity bit (if present). Various embodiments can have a varying number and/or combination of start, character, and/or end bits, so long as the pattern of start and stop bits can be distinguished over a number of frames.

After being decoded from the Manchester format, the data remains in TDEA/DUKPT encrypted format or other encrypted format such as AES. Typically, the device receiving the data is unable to access the encrypted data in the clear and so the data can be securely transmitted to a processing facility (206). Transmission can be over any private or public network. Cell phones are typically configured to communicate over at least cellular networks, WiFi (802.11) networks, and Bluetooth paired networks. However, any other wired or wireless communication protocol supported on a device can be utilized in accordance with embodiments of the invention.

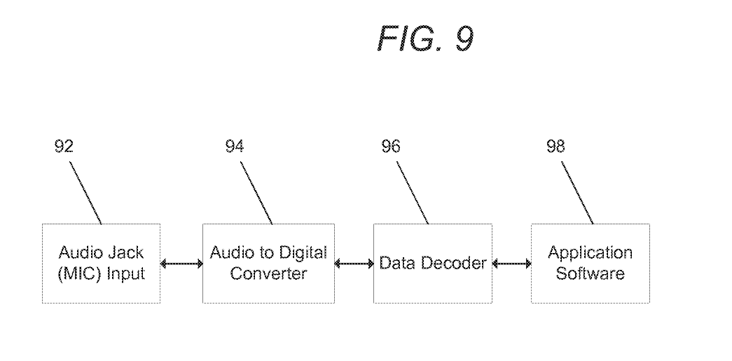

A functional block diagram of a mobile phone configured to receive data from a secure magnetic stripe card reader in accordance with an embodiment of the invention is shown in FIG. 9. The phone has an audio jack input 92 which can be connected to the audio jack 12 of a secure magnetic stripe card reader. When connected, a signal is received on the microphone (MIC) channel of the audio jack input 92. The signal is sampled and processed by an Analog to Digital Converter (ADC) 94. Several embodiments of the invention are configured for a 44.1 KHz sampling rate, providing an approximately 20 times oversample of the 2 KHz Manchester encoded data signal. Sampling can also be performed at other rates such as 22,050 Hz, 48 KHz, or 96 KHz. In other embodiments, any of a variety of sampling rates appropriate to a specific application can also be utilized. Many advantages to oversampling exist as discussed above.

A data decoder 96 reconstructs the samples of the Manchester encoded data into an approximation of the original signal and decodes the data from the Manchester format. The decoding algorithm can be implemented in hardware or in software as an application on the cell phone. Because Manchester coded data inherently contains a clock signal, the receiver can synchronize to the transmitter's clock after receiving two or more data bits. The decoding algorithm detects low-to-high and high-to-low transitions in the signal and translates them to logic low and logic high bits in a reverse process to the encoding process described above.

In a number of embodiments, data is arranged into character frames, and the decoding process is designed to detect start and stop bits, and check against a parity bit if one is used. The decoding process detects the transition between frames. Various embodiments can have a varying number and/or combination of start, character, and/or end bits, so long as the pattern of start and stop bits can be distinguished over a number of frames.

After being decoded from the Manchester format, the data remains in TDEA/DUKPT encrypted format (or other encrypted format such as AES) and is transmitted by application software 98 via a microprocessor and/or other network communications circuitry to a processing facility. In several embodiments, data decoder 96 and application software 98 are implemented in a single application. As discussed above, transmission can be over any private or public network.

A device receiving data from a secure magnetic card reader in accordance with various embodiments of the invention utilize hardware or software buffers to communicate data between ADC 94 and data decoder 96, between data decoder 96 and application software 98, and in transmission from application software 98 to a processing facility. Other embodiments of the invention utilize a data streaming process to pass the data.

Various embodiments of the invention provide power to the secure magnetic card reader via voltage/current applied to channels/conductors of the audio jack input of the device receiving data from the secure magnetic card reader, such as the conductors for left and right audio channels. The voltage and current provided can be dependent on the capabilities of the device and the requirements of the secure magnetic card reader.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method of securely capturing and communicating data from a magnetic stripe bearing document, comprising:
reading data from at least one track of data encoded on a magnetic stripe using a magnetic read head;
encrypting the data using an encryption circuit;
encoding the encrypted data into a transmission format using an encoder;
passing the encoded data through an anti-aliasing filter to generate a data signal; and
transmitting the data signal on the microphone channel of an audio jack.

2. The method of claim 1, further comprising:
detecting a unique magnetic characteristic that is inherent to the magnetic materials used to form the magnetic stripe of the magnetic stripe bearing document using the magnetic read head;
encrypting a unique identifier derived from the detected unique magnetic characteristic; and
combining the encrypted data read from the at least one track of data with the encrypted unique identifier.

3. The method of claim 1, wherein encrypting the data comprises encrypting the data using Triple DES Encryption Algorithm (TDEA) and Derived Unique Key Per Transaction (DUKPT).

4. The method of claim 1, wherein encoding the encrypted data into a transmission format comprises encoding the encrypted data using a Manchester code.

5. The method of claim 4, wherein encoding the encrypted data using Manchester code is performed using a 2 KHz clock signal.

6. The method of claim 4, further comprising arranging the Manchester encoded data into character frames.

7. The method of claim 5, wherein arranging the Manchester encoded data into character frames comprises arranging the Manchester encoded data into 10 bit character frames.

8. The method of claim 1, wherein transmitting the data signal on the microphone channel of an audio jack comprises applying a voltage to the microphone channel where the voltage is representative of the data signal.

9. The method of claim 8, wherein the voltage is 0 V for a logic low and 3 V for a logic high.

10. A secure magnetic stripe reader, comprising:
a magnetic read head configured to read and encrypt data from a magnetic stripe;
a microcontroller connected to the magnetic read head and configured to convert encrypted data received from the magnetic read head into a transmission format; and
an anti-aliasing filter connected between the microcontroller and a multi-channel audio jack, where the anti-aliasing filter is configured to output a transmission signal based upon data provided as an input in the transmission format.

11. The system of claim 10, wherein the magnetic read head is also configured to detect a magnetic fingerprint from a magnetic stripe.

12. The system of claim 10, further comprising a sensing unit to detect a unique magnetic characteristic that is inherent to the magnetic materials used to form the magnetic stripe of a magnetic stripe bearing document.

13. The system of claim 10, wherein the magnetic read head encrypts the data with Triple DES Encryption Algorithm (TDEA) and Derived Unique Key Per Transaction (DUKPT).

14. The system of claim 10, wherein the microcontroller is configured to generate Manchester encoded data.

15. The system of claim 14, wherein the microcontroller is configured to generate a 2 KHz signal as a clock signal.

16. The system of claim 10, wherein the multi-channel audio jack is a 3.5 mm TRRS connector with a microphone channel.

17. The system of claim 10, further comprising a rechargeable battery configured to provide power to circuitry within the magnetic card reader.

18. The system of claim 17, further comprising a micro USB port connected to a charging circuit that is connected to the rechargeable battery.

19. A method of securely receiving encrypted data from a secure magnetic stripe card reader, comprising:
receiving a signal on the microphone channel of a cell phone audio jack;
sampling the signal with an analog to digital converter;
decoding the data in the signal from its transmission format to obtain encrypted data; and
transmitting the encrypted data to a transaction processor.

20. The method of claim 19, wherein sampling the signal with an analog to digital converter comprises sampling at 44.1 KHz.

21. The method of claim 19, wherein decoding the data in the signal from its transmission format comprises decoding a Manchester encoded data signal.

22. A system for securely receiving encrypted data from a secure magnetic stripe card reader, comprising:
an audio jack input configured to receive a transmitted signal;
an analog to digital converter configured to sample the received signal;
a data decoder configured to decode the sampled signal to obtain the encrypted data; and
a processor configured by an application to send the encrypted data to a transaction processor.

23. The system of claim 22, wherein the analog to digital converter is configured to sample at 44.1 KHz.

24. The system of claim 22, wherein the data decoder is configured to decode Manchester encoded data.

25. The system of claim 22, wherein the audio jack input is configured to output electrical power on one or more conductors.
